(19) United States
(12) Patent Application Publication
(10) Pub. No.: US 2008/0078630 A1
(43) Pub. Date: Apr. 3, 2008

(54) Wheel brake mechanism for a baby stroller

(75) Inventor: Po-Shiung Yeh, Tainan County (TW)

Correspondence Address: BIRCH STEWART KOLASCH & BIRCH, PO BOX 747, FALLS CHURCH, VA, 22040-0747, US

(73) Assignee: GOLDEN POINT MARKETING LIMITED

(21) Appl. No.: 11/709,198

(22) Filed: Feb. 22, 2007

(30) Foreign Application Priority Data
Sep. 29, 2006 (TW) 095217404

(51) Int. Cl. B62B 9/08

(52) U.S. Cl. 188/20

(57) ABSTRACT

A wheel brake mechanism for a baby stroller has a pair of sliders which can be released from and engaged with a toothed portion of a pair of rear wheels. The pair of sliders are driven by a pedal via a transmission shaft. The pedal has a rear end and a front end. A user may step downwardly on the rear end of the pedal to simultaneously brake the rear wheels on either side of the stroller; and step on the front end of the pedal to simultaneously release the rear wheels from a braked state.

### FIELD OF THE INVENTION

The present invention relates to a brake mechanism for a baby stroller and in particular, to a brake mechanism with a pedal which is operable in either a front direction or a rear direction.

### DESCRIPTION OF THE RELATED ART

There are many mechanisms and methods being used commercially for braking a baby stroller. The basic type of mechanism is furnished with a pedal having a toothed portion operatively connected to a rear wheel. The rear wheel also has an engageable toothed portion for detachably engaging with the toothed portion of the pedal, in order to brake the stroller.

As the pedals are separately installed on both sides of a stroller, the brake mechanisms cannot be operated simultaneously. The baby stroller may therefore lose its balance and cause the baby to fall out of the stroller when brake are applied suddenly at a high speed.

For fast movement of a baby stroller or a jogger on a steep or rugged road, it is preferable to brake the rear wheels of the stroller or the jogger simultaneously, to increase safety and avoid unwanted accidents while braking. A requirement that the rear wheels on both the right and left sides of the stroller or the jogger be braked simultaneously, is now part of the British safety standard for stroller products.

As an example, German Patent DE29818659U1 discloses a baby stroller with a brake device that is capable of braking or releasing the left and right side rear wheels simultaneously.

The brake device of the German patent is controlled by a control plate. The control plate is used to drive a tubular braking element which can be moved along its axial direction. The control plate therefore brakes or releases the wheels of a stroller. Accordingly, the user can step down on the control plate with their shoes in order to brake the stroller, and hook up the plate using their shoe tip in order to release the braked state.

Another example is disclosed in U.S. Pat. No. 5,460,399. This patent has a pedal capable of lifting upward and stepping downward to drive a pair of braking rods. The bottom of the pedal is furnished with a pair of slanted surfaces to keep the pedal in an inclined position. To brake the stroller, a user can step down on the pedal to push the braking rods axially along the slanted surface. To release the brake, a user can hook up the pedal upward using their shoe tip.

In order to control the brake device of the prior art as described above, a user must use the tip of their shoe to hook up the pedal or control plate, which may damage the surface of the user's shoe.

### SUMMARY OF THE INVENTION

In order to avoid possible damage to the surface of the user's shoes during operation of the brake device, the present invention provides an improved brake mechanism of a baby stroller, that is controllable simply by stepping on either the front or rear end of a pedal.

The brake mechanism according to the present invention may comprise a pair of connecting elements, a pedal, a transmission shaft and a pair of sliders. Each of the connecting elements is pivotally connected with a wheel having a toothed portion for detachably engaging with the slider, so as to brake the wheel.

The pair of connecting elements are connected to the rear leg tubes on each side of the stroller. Each connecting element has a guiding slot for receiving and guiding the slider to engage and disengage with the toothed portion of the wheel.

Each of the sliders is biased by a resilient element mounted in the connecting element, to thereby disengage from the toothed portion of the wheels.

The transmission shaft is pivotally connected between the pair of connecting elements and rotatable by a pedal. Each end of the transmission shaft has an extended portion for biasing the sliders to simultaneously engage with the toothed portion of the wheels into a brake state.

It would be more safe and convenient for a user to brake and release the brake mechanisms on either sides of the stroller simultaneously simply by stepping on the front or rear end of the pedal.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein:

FIG. 1 is an exploded perspective view of the present invention connected with a pair of rear leg tubes of a baby stroller.

FIG. 2 is a schematic view showing an embodiment of the brake mechanism according to the present invention, wherein the slider is biased by the protruded portion of the transmission shaft and engaged with the toothed portion of the wheel, to thereby keep the stroller in a brake state.

FIG. 3 is a schematic view showing the rear end of the pedal of the brake mechanism of FIG. 2 having been pressed downward, driving the slider to engage with the toothed portion of the wheel in a brake state.

FIG. 4 is a schematic view showing an embodiment of the brake mechanism of FIG. 2, wherein the slider is biased by the resilient element to disengage from the toothed portion of the wheel, thereby keeping the stroller in a non-brake state.

FIG. 5 is a schematic view showing the front end of the pedal of the brake mechanism of FIG. 2 having been pressed downward, wherein the slider is released and disengaged from the toothed portion of the wheel in a non-brake state.

### DETAILED DESCRIPTION OF THE PREFERRED EMBODIMENTS

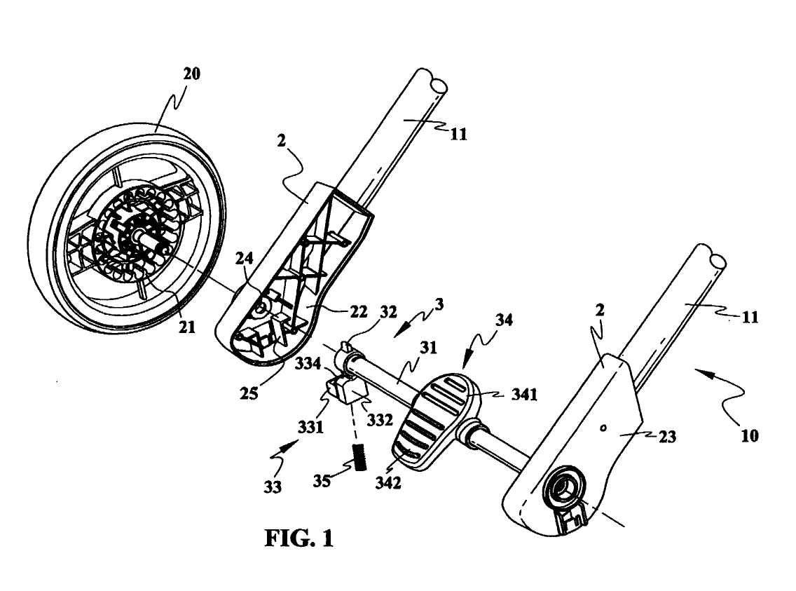

Referring to FIG. 1, an embodiment of a brake mechanism 3 connects to a pair of rear leg tubes 11 of a stroller frame 10. The brake mechanism 3 includes a pair of connecting elements 2, a pedal 34, a transmission shaft 31 and a pair of sliders 33. Each of the connecting elements 2 is pivotally connected with a wheel 20 which has a toothed portion 21 for detachably engaging with the slider 33 to brake the wheel 2.

The pair of connecting elements 2 are connected to the rear leg tubes 11 respectively at the top end thereof. Each connecting element 2 has a wall 23 which is formed with an inner space 22, a axle hole 24, and a guiding slot 25. The wheel 20 is pivotally installed on the axle hole 24. The slider 33 is slidably received within the guiding slot 25. Further, the inner space 22 is installed with a resilient element 35 for biasing the slider 33 to disengage from the toothed portion 21 of the wheel 20.

The pedal 34 is connected to the transmission shaft 31 and has a front end 341 and a rear end 342. A user can step on either the front end 341 or rear end 342 to drive the transmission shaft 31 in a respective direction, as shown by the arrows in FIGS. 3 and 5, for either driving or releasing the slider 33.

The transmission shaft 31 has two ends, each comprising a protruded portion 32 used to slidably abut the slider 33. When the transmission shaft 31 is rotated by the pedal 34 as described, the protruded portion 3 may bias and drive the slider 33 to engage with the toothed portion 21 of the wheel 20. The protruded portion has a cam surface for driving the slider 33 to engage with the toothed portion 21 of the wheel 20.

As will be appreciated, the slider 33 may include a engagement portion 331 and a driving portion 332. The driving portion 332 is formed with a curved surface 334. The curved surface 334 is functional for slidably abutting with the protruded portion 32 of the ends of the transmission shaft 31. The resilient element 35 can be a compression spring installed between the driving portion 332 and the wall 23 of the connecting element 2.

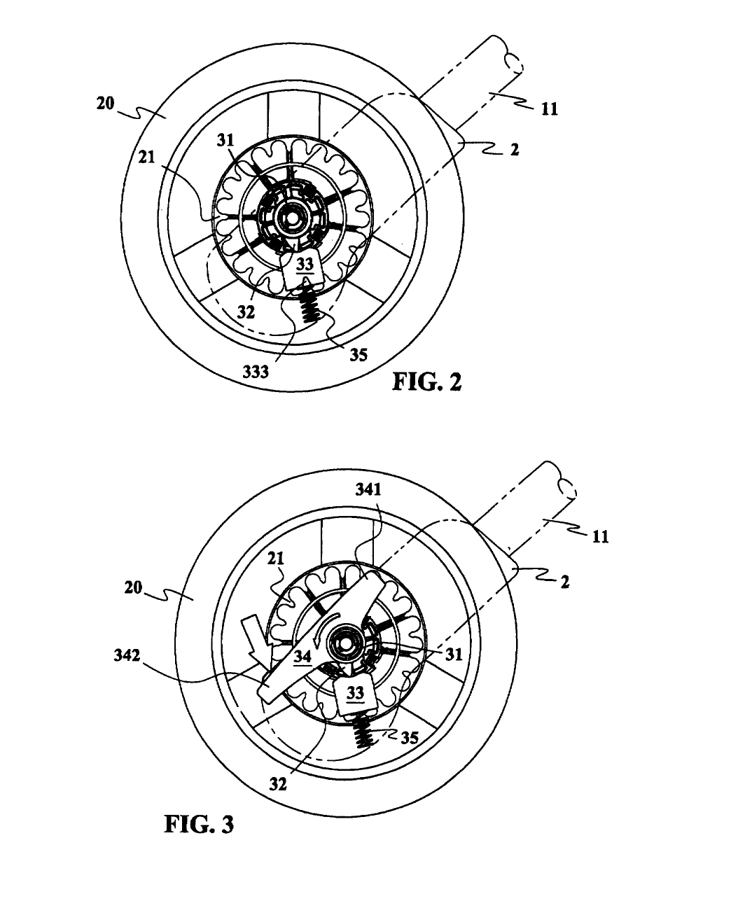

Referring to FIGS. 2 and 3, the engagement portion 331 of the slider 33 may be formed with a recess 333. When the rear end 342 of the pedal 34 is pressed downward, the protruded portion 32 of the ends of the transmission shaft 31 drives the slider 33 to slide, thereby moving the recess 333 to engage with toothed portion 21 of the wheel 2.

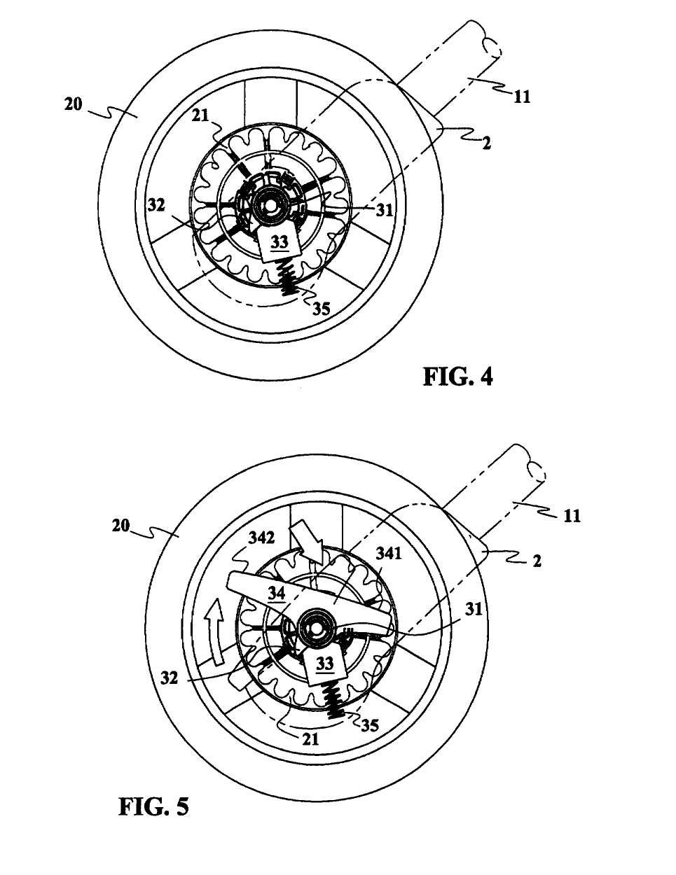

Referring to FIGS. 4 and 5, when the front end 341 of the pedal 34 is pressed downward, the protruded portion 32 of the ends of the transmission shaft 31 is rotated, and dismisses the biasing on the slider 33. This allows the biasing force of the resilient element 35 to push the slider 33, so as to disengage from the toothed portion 21 of the wheel 2.

By stepping downwardly on either ends of the pedal 34, the rear wheels 20 can be either braked or released simultaneously.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A wheel brake mechanism for a baby stroller, comprising:
a pair of connecting elements, connected to a pair of rear leg tubes of the stroller, each connecting element having an axle hole and a guiding slot;
a pair of wheels pivotally connected on the axle holes of the pair of connecting elements, each wheel having a toothed portion for braking;
a pair of sliders slidably received within the guiding slots of the connecting elements sliding in a radial direction of each wheel for either engaging or disengaging with the toothed portion of the wheels;
a pair of resilient elements installed inside the pair of connecting elements for biasing the sliders to disengage from the toothed portion of the wheels;
a transmission shaft pivotally connected between the pair of connecting elements and having two ends, each end having a protruded portion for slidably abutting on the sliders; and
a pedal connected with the transmission shaft, having a front end and a rear end.

2. The wheel brake mechanism of claim 1, wherein the pair of sliders is reciprocally guided by the guiding slots of the connecting elements.

3. The wheel brake mechanism of claim 1, wherein each of the pair of sliders has a curved surface to slidably abut the protruded portion of the transmission shaft and engages with the toothed portion of the wheel.

4. The wheel brake mechanism of claim 1, wherein each of the pair of sliders each has an engagement portion for engaging with the toothed portion of the wheel.

5. The wheel brake mechanism of claim 4 wherein the engagement portion has a recess for engaging with the toothed portion of the wheel.

6. The wheel brake mechanism of claim 1, wherein the resilient element is a compression spring.

7. The wheel brake mechanism of claim 1, wherein the protruded portion has a cam surface for driving the slider to engage with the toothed portion of the wheel.

8. The wheel brake mechanism of claim 1, wherein the protruded portion is rotated in a direction by a stepping on the rear end of the pedal, to drive the slider to engage with the toothed portion of the wheel.

9. The wheel brake mechanism of claim 8, wherein the wherein the protruded portion is rotated in an opposite direction by a stepping on the front end of the pedal to disengage the slider from the toothed portion of the wheel.
